(19) United States
(12) Patent Application Publication
(10) Pub. No.: US 2013/0262652 A1
(43) Pub. Date: Oct. 3, 2013

(54) ARTICLES OF MANUFACTURE, SERVICE PROVIDER COMPUTING METHODS, AND COMPUTING SERVICE SYSTEMS

(71) Applicants: Tijl Vuyk, Bourne End (GB); Cornelis Arnold Verruijt, Harlingen (NL); Thomas Andrew Evers, Raleigh, NC (US)

(72) Inventors: Tijl Vuyk, Bourne End (GB); Cornelis Arnold Verruijt, Harlingen (NL); Thomas Andrew Evers, Raleigh, NC (US)

(21) Appl. No.: 13/431,762

(22) Filed: Mar. 27, 2012

(51) Int. Cl. G06F 15/173

(52) U.S. Cl. 709/224

(57) ABSTRACT

Articles of manufacture, service provider computing methods, and computing service systems are described. According to one aspect, an article of manufacture includes a computer-readable storage medium storing programming configured to cause processing circuitry of a client computing device within a client network to perform processing comprising creating an outbound network connection to a service provider which is external of the client network and which is to provide computing services to the client network, accessing an inbound communication from the service provider received via the outbound network connection during the providing of the computing services by the service provider to the client network, and communicating data of the inbound communication to another client computing device within the client network.

### TECHNICAL FIELD

This disclosure relates to articles of manufacture, service provider computing methods, and computing service systems.

### BACKGROUND OF THE DISCLOSURE

A network router routes network packets of data between different networks. A commonly used communications protocol is the Internet Protocol (IP) which is responsible for routing packets across network boundaries. For example, routers in the transmission path forward packets to the next known local gateway matching the routing prefix for the destination address.

Layered on top of the Internet Protocol are higher level protocols such as UDP and TCP. Some routers have knowledge of these protocols in order to perform packet inspection and decide whether to forward, drop or reject the packet. Such a router is known as a firewall. Given the level of threats on the internet, organizations typically utilize a firewall between its internal network and the internet.

Some network routers (e.g., those routing between a Local Area Network (LAN) and a Wide Area Network (WAN) such as the internet) may reduce the number of IPv4 addresses used by the LAN via a technique, such as Network Address Translation (NAT), since the number of unassigned IPv4 addresses has been decreasing steadily. NAT has the effect that an entire LAN may be represented by a single IP address on its WAN side. For example, NAT is a process whereby an outbound network connection is modified such that the source address of the network packet, which may be the address of the LAN device, is replaced with the address of the router itself. A recipient that receives this packet may route reply packets back to the router, since that is where the recipient believes the packet came from. The router may use an internal state to reroute the reply packets to the original source address.

Over the last few years, a trend has been growing where some organizations may use other computing organizations for computer software services, with the physical presence of these software services being somewhere else than in the physical buildings of the organization itself which utilizes the services, and perhaps outside of the local area network of the organization. The acquirer relinquishes a certain amount of control over the physical computing resources to the provider in these arrangements.

Cloud computing refers to arrangements wherein a provider grants access to computing services services to an acquirer via the internet, and the acquirer may have no authority or ownership of the actual computers or software of the cloud. Cloud computing may be different from outsourcing or a computing service in that the customer typically does not know what the physical computer is, nor where it is located, nor how it is configured which aspects may be provided by the cloud computing provider.

At least some of the apparatus and methods disclosed herein are directed towards providing computing services to clients and some of the disclosed embodiments are directed towards cloud based computing arrangements.

### BRIEF DESCRIPTION OF THE DRAWINGS

Exemplary embodiments of the disclosure are described below with reference to the following accompanying drawings.

FIG. 1 is functional block diagram of a client network according to one embodiment.

FIG. 2 is a functional block diagram of a client network and a computing service system according to one embodiment.

FIG. 3 is a functional block diagram of a computing device according to one embodiment.

FIG. 4 is a flow chart of a method creating a network connection between a client network and a computing service system according to one embodiment.

FIG. 5 is a flow chart of operations of a computing service system for providing computing services to a client network according to one embodiment.

FIG. 6 is a flow chart of operations of client computing devices with respect to computing services provided by a computing service system according to one embodiment.

### DETAILED DESCRIPTION OF THE DISCLOSURE

As discussed herein in accordance with some embodiments of the disclosure, apparatus and methods are described wherein an entity, such as a service provider, may provide computing services to other entities, which may be referred to as clients. Some embodiments provide a cloud computing arrangement wherein a client receives computing services from the service provider. In some example embodiments, the service provider may communicate programming, such as a reverse routing proxy, to the client and which may be installed on a computing device within a client network which enables or facilitates the provision of the computing services to the client by the service provider. As discussed in additional detail below in these example embodiments, the reverse routing proxy may create an outbound network connection to a computing device of the service provider and which connection may be utilized by the computing device of the service provider to provide inbound communications to one or more computing devices within the client network. Additional embodiments and aspects of the disclosure are described in detail below.

According to one embodiment, an article of manufacture comprises a computer-readable storage medium storing programming configured to cause processing circuitry of a client computing device within a client network to perform processing comprising creating an outbound network connection to a service provider which is external of the client network and which is to provide computing services to the client network, accessing an inbound communication from the service provider received via the outbound network connection during the providing of the computing services by the service provider to the client network, and communicating data of the inbound communication to another client computing device within the client network.

According to an additional embodiment, a service provider computing method to provide computing services to a client comprises creating a network connection with a first client computing device of a client network to which computing services are to be provided, after the creating, executing an application to provide the computing services, during the executing of the application, creating a communication comprising data to be transmitted to a second client computing device of the client network, and outputting the communication to the network connection for transmission to the second client computing device.

According to another embodiment, a computing service system comprises communications circuitry configured to create a network connection with a client computing device of a client network, storage circuitry configured to store an application, and processing circuitry coupled with the communications circuitry and the storage circuitry, wherein the processing circuitry is configured to access a request for computing services, execute the application as a result of the accessing the request, and create data as a result of the execution of the application, and wherein the communications circuitry is configured to output a communication comprising the data to the network connection for communication to the client computing device.

As mentioned above, some embodiments are directed towards cloud based computing arrangements. Enabling factors for some cloud based computing arrangements are the ubiquity of internet access and web browsers capable of functioning as user interfaces for the computing services which enable users to access and use the computing services of the service provider as if the programs were installed locally on their own computing devices within their own local network.

Some types of software lend themselves easily to being provided as a cloud service. For instance, a static website that has no need for integration with other computer software of a client organization can be hosted somewhere else. Slightly higher in complexity is a cloud-based storage service which allows clients to store blocks of data in the cloud. Additional example cloud-based services may provide interfaces usable for automation as well as human users and machine-to-machine interfaces may be called Web services. For example, a cloud-based financial package, such as a general ledger package, may offer services to provide data upload/download to/from other sources.

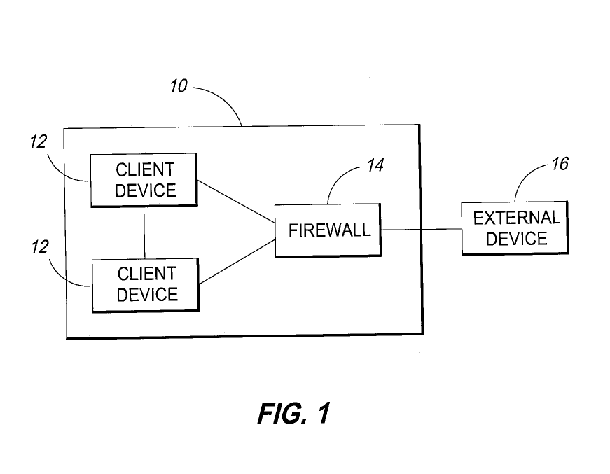

Referring to FIG. 1, a client network 10 is shown according to one illustrative example. The client network 10 includes a plurality of client computing devices 12 which may be personal computers, servers, workstations, databases, etc. In one example, the client network 10 may correspond to a local area network of an organization such as a corporation, university or other entity. The client network 10 may have access to external devices 16 which may be devices of external networks, such as the Internet, other networks, or other computing devices which may communicate and exchange information with the client computing devices 12 within the client network 10.

Client network 10 may often include a firewall 14 to protect the client network 10 and client computing devices 12 thereof from threats originating externally of the client network 10. The nature of the Internet routers with its firewalls and NAT is that it is relatively easy to create an outbound network connection, for instance from a web browser on a client computing device 12, to an external device 16, for example, in the form of an HTTP server. However, it may be more difficult to create an inbound network connection with respect to the client network 10 due to protections offered by the firewall 14 since a purpose of the firewall 14 is to refuse incoming network connections which may originate from either a targeted attack to the client network 10 or an automated computer virus in but a few examples.

Firewall 14 is a TOP-level firewall in one embodiment. Firewall 14 may be instructed via firewall rules to allow certain inbound connections. Doing this in a safe manner is complex and often utilizes authentication and perhaps encryption. Authentication is utilized so that the firewall 14 can ascertain that an external device 16 is in fact an authorized device that should be allowed to communicate with the client network 14. Encryption is advisable so that other external devices cannot listen in on the connection and obtain confidential information, possibly including data on how to surreptitiously enter the private client network 10.

Accordingly, inbound connections typically require configuration of the network defense mechanisms to permit authorized inbound connections. In some cases, the security requirements made by the client network 10 will be incompatible with the nature of cloud computing. For instance, if the cloud computing service is highly available, scalable and/or dynamic, it may be impossible or require effort to state which IP address an inbound request originates from. Thus, the inbound firewall 14 may not be able to filter on an IP address, it may require reconfiguration when the IP address changes or client policy may prevent such inbound connections to firewall 14 from being created in some examples.

According to one embodiment described herein, an outbound network connection may be utilized for inbound communication traffic with respect to the client network 10. In some example embodiments described herein, outbound network connections are network connections which originate from a client computing device 12 within the client network 10 and inbound communication traffic refers to external communications from an external device 16 which are directed to the client network 10.

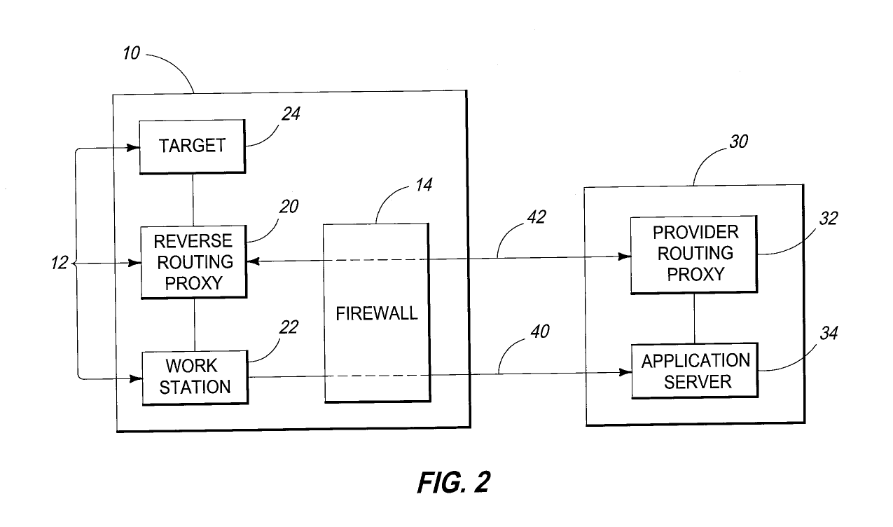

Referring to FIG. 2, additional details of an example client network 10 are shown as well as an example arrangement of a computing service system 30 of a service provider which may provide computing services to the client network 10. In one embodiment, computing service system 30 is implemented in a cloud computing arrangement to provide the computing services to the client network 10. Some example computing services which may be provided by the computing service system 30 for illustration include storing data of the client, accessing and processing data of the client, and generating reports for the client and/or other entities.

The illustrated example client network 10 of FIG. 2 includes a plurality of client computing devices 12 including a reverse routing proxy 20, work station 22, and target 24. The illustrated devices are merely for illustrating example embodiments of the client network 10 and client network 10 may include additional computing devices 12 or other arrangements in other implementations of the client network 10, including firewalls or other network elements such as routers or proxy servers.

In one embodiment, reverse routing proxy 20 is a computing device which is configured to implement communications with respect to computing service system 30 as discussed in additional detail below. In one more specific example, reverse routing proxy 20 may facilitate communications of the client network 10 with the computing service system 30 including facilitating communication of inbound communications originating from the computing service system 30, such as communications regarding the computing services provided to the client.

A user, such as an employee of the client, may operate work station 22 to communicate with the computing service system 30 and utilize, configure, implement, order or facilitate the computing services provided by the computing service system 30 to the client.

A computing device 12 may be configured as a target 24 which may be accessed by computing service system 30 during the provision of the computing services to the client. For example, target 24 may include a database which includes information which is needed to be accessed by the computing service system 30 as part of the provision of the computing services to the client. Depending upon the size of the client, the computing service system 30 may access multiple targets 24 of the client, for example, which may be located in different geographical locations, different countries, have different formats or configurations, etc.

As discussed above, the firewall 14 of the client network 10 provides protection from inbound communications which originate externally of the client network 10. However, this protection may make it difficult for computing devices of the computing service system 30 to communicate with computing devices 12 of the client network 10 to provide the computing services to the client.

As also mentioned above, reverse routing proxy 20 is configured to facilitate communications of the client network 10 with the computing service system 30 including communications with respect to the computing services provided to the client by the computing service system 30. In one embodiment, a software agent containing programming for the reverse routing proxy functionality may be downloaded or otherwise provided to the client. In one more specific example, an employee of the client may use a web browser of work station 22 to make a connection 40 to an appropriate server 34 or other entity of the computing service system 30 and download the software agent via connection 40. The software agent may be installed on one of the computing devices 12 of the client network 10 to configure the computing device 12 as the reverse routing proxy 20 which is described further below. The software agent may be installed on more than one computing device 12 of the client network 10 in some implementations.

In this described example, no additional configuration of network routers is needed beyond that required to use the web browser to access the computing service system 30 to access the software agent which contains the reverse routing proxy functionality. Since the reverse routing proxy 20 is located on a computing device 12 within the internal client network 20, the proxy 20 can access the internal computing devices 12 of the client network 10 and services of the client network 10 in this described example.

In one embodiment, the reverse routing proxy 20 initiates a communication to the provider routing proxy 32 to create the outbound network connection 42 following the configuration of the respective computing device 12 as the proxy 20. The proxy 20 may automatically initiate the creation of the outbound network connection 42 without user interaction instructing the creation of the connection in one embodiment. The reverse routing proxy 20 and provider routing proxy 32 create the outbound network connection 42 in the form of a TCP connection in one embodiment. The outbound network connection 42 which was initiated by the reverse routing proxy 20 may be utilized by the computing service system 30 to implement inbound communications with respect to the client network 10 during the provision of computing services to the client as discussed further below. In one embodiment, the reverse routing proxy 20 does not need any configuration data other than that required to set up connection 42 (e.g., address of proxy 32). All information required to set up communications with computing devices 12 in client network 10 (e.g., addresses of the client computing devices) may be sent to it from provider routing proxy 32 which in turn may receive this from application server 34 which in turn may receive this from the user workstation 22 in one embodiment.

In one example, a client user may utilize a web browser of work station 22 to access and instruct or configure (e.g., via a connection 40) the computing service system 30 of the specific computing services to be provided to the client. In one illustrative example, the computing service system 30 may provide computing services to the client with respect to job scheduling. In another example, the computing service system 30 may provide inventory monitoring and ordering functionality to the client. These computing services are illustrative and the computing service system 30 may provide other types of computing services in other embodiments.

The reverse routing proxy 20 and provider routing proxy 32 can use a single TCP connection, such as connection 42, to facilitate any number of tunneled connections, either sequentially or in parallel, from any embodiment of application server 34 or other service provider computing devices to any embodiment of target 24 or other computing devices in client network 10 or any other network reachable from the reverse routing proxy 20. In one embodiment, the proxies 20, 32 may label packets which are transferred via connection 42 with respective identifiers which identify the respective tunneled network connections to which the packets belong.

Computing service system 30 includes an application server 34 in the illustrated implementation which includes one or more applications, also referred to as sources, which provide desired computing services to the client. During the provision of computing services to the client network 10, one or more applications of the server 34 may create communications for transmission to the client network 10 to provide the computing services as discussed in additional detail below. System 30 may also include additional computing devices, servers, etc. which may also provide computing services to computing devices 12 within the client network 10 and such additional computing devices of the system 30 may also create communications for transmission to the computing devices 12 of the client network 10 to provide the computing services. Furthermore, the hardware resources of the system 30 may change over time and some arrangements of the disclosure provide flexibility permitting different computing devices of the system 30 to create and transmit communications through the firewall 14 to computing devices 12 within the client network 10. Furthermore, as discussed in detail below in some embodiments, reverse routing proxy 20 receives inbound communications from the system 30 via the outbound network connection and directs the communication to different computing devices 12 within the client network 10 since the reverse routing proxy 20 is on the inside of the network 10 (with respect to the firewall 14) and can access other computing devices 12 of the network 10.

Following the construction of the outbound network connection 42, the appropriate application(s) of the application server 34 may serve web pages to the workstation 22 through the provider routing proxy 32, outbound network connection 42 and reverse routing proxy 20 to configure the computing services to be provided to the client. In one example, a client user may submit a request to the computing service system 30 via work station 22 and connection 40 and the respective application of the application server 34 which is to provide the computing services to the client network 10 may serve appropriate web pages to the client user through the outbound network connection 42 and which are directed to work station 22 by the reverse routing proxy 20. The reverse routing proxy 20 receives and processes the packets of received communications (e.g., web pages in this example) to determine which appropriate client computing device 12 to forward the communication to via the client network. The application of the server 34 may identify the intended destination by any appropriate manner including using addresses or ports which may be specified by the client user. Accordingly, the proxy 20 forwards the packets of the web pages to the work station 22 in this example. In another example, the server 34 may serve web pages via connection 40.

During the provision of the computing services to the client, an application of the computing service system 30 may need to access other computing devices 12 of the client network 10. The client user 22 may interact with the received web pages received via network connections 40 or 42 to initiate, specify, order, configure, modify, provide requested information, control and/or implement the provision of the computing services by the computing service system 30 to the client network 10 in one embodiment. For example, the client user may use the web pages to identify a target 24 which includes information which may need to be accessed by the application to perform the computing services and the application running on application server 34 may thereafter use this information regarding target 24 to contact target 24 via the connection 42 and reverse routing proxy 20 in order to perform the requested computing services. In another example, the client user may identify another computing device 12 of the client which is utilized by an employee of the organization who is responsible for review of reports generated by the system 30 and to which the system 30 forwards these reports upon creation.

The appropriate application(s) being utilized formulate inbound communications with respect to the client network 10 to provide the computing services. For example, the application may serve web pages to work station 22, formulate a request for information from target 24, instruct target 24 to perform certain actions, communicate reports or other information. In one more specific example, the application formulates the contents of a communication and addresses the communication with an appropriate identifier of the recipient computing device 12 of the network 10 who is to receive the communication. The application directs the communication to the provider routing proxy 32 which transmits the communication to the reverse routing proxy 20 using the outbound network connection 42 and the reverse routing proxy 20 forwards the communication via the client network to the appropriate recipient as discussed in additional detail below.

Accordingly, the reverse routing proxy 20 may operate in cooperation with the provider routing proxy 32 in the computing service system 30 to implement inbound communications from the computing service system 30 to the client network 10 as well as outbound communications from the network 10 to the system 30. The provider routing proxy 32 may tunnel the packets of the communications through the outbound network connection 42 to the reverse routing proxy 20 and the outbound network connection 42 may be referred to as a tunneled connection in one embodiment.

Once outbound connection 42 has been created, the provider router proxy 32 and reverse routing proxy 20 are able to send network packets to each other at will in one embodiment.

In another embodiment, firewall 14 may insist on particular content and flow of network packets. Creating appropriate wrappers around packet content can accommodate such restrictions on the flow and order of packets. For example, if the firewall 14 insists that the network traffic between proxies 20, 32 be in the form of unencrypted HTTP connections, then the network content passing between proxies 20, 32 may be in the form of HTTP requests and responses, and the content section of the requests and responses include data that the proxies 20, 32 desire to exchange, for example to enable the service system 30 to provide computing services to the client network 10.

In some embodiments, the firewall 14 may implement strict ordering over whether either the provider routing proxy 32 or the reverse routing proxy 20 is allowed to send a data stream at a moment in time. In such cases, reverse routing proxy 20 may set up multiple instances of connection 42. In this described example, the reverse routing proxy 20 and provider proxy 32 can both have a connection kept in a state such that it is free to send arbitrary content to the other party at desired moments in time.

Accordingly, proxies 20, 32 can send arbitrary communications to each other in some embodiments which may include commands that instruct the recipient on how to process communications received either from the other proxy or from the networks 10, 30.

The reverse routing proxy 20 may process the inbound packets to determine the appropriate recipient computing devices 12 which are to receive the packets in one embodiment. Some communications from the application of the system 30 may include a connection request to one of the computing devices 12. Following the identification of the appropriate recipient computing device 12, the reverse routing proxy 20 may create a new network connection from the proxy 20 to the appropriate device 12 within the client's internal network 10 and the proxy 20 may forward the packets of the communication from the computing service system 30 to this connection and the recipient computing device 12.

As discussed above, a client user may specify an action to be implemented by the computing service system 30 and which may utilize a network connection to one of the computing devices 12 in the client network to perform the action (e.g., the service provider may request data stored within target 24 during the provision of the computer services). The respective application of the application server 34 which is providing the computing services may generate a network connection request to connect to target 24. The application server 34 may forward a communication which includes the network connection request to provider routing proxy 32. Provider routing proxy 32 may tunnel packets of the communication via connection 42 to the reverse routing proxy 20. The reverse routing proxy 20 thereafter forwards the connection request to target 24. From the point of view of the target 24, the connection request originated from the reverse routing proxy 20 as opposed to the computing service system 30 in the presently-described example. The target 24 and proxy 20 may establish the network connection and the packets may be forwarded to the target 24.

In this example, a client user may enter connection details in the computing service system 30 as if the services were located in the internal network of the client network 10 without requiring any knowledge of the computing service system 30 such as configuration or location. Accordingly, in one embodiment, the reverse routing proxy 20 not only enables this functionality by passing inbound communications through the firewall 14, it also provides this functionality and security with reduced administration or configuration as it uses outbound network connection 42 for inbound communications in this embodiment and as compared with other arrangements which may be used to direct inbound communications through firewalls of client networks.

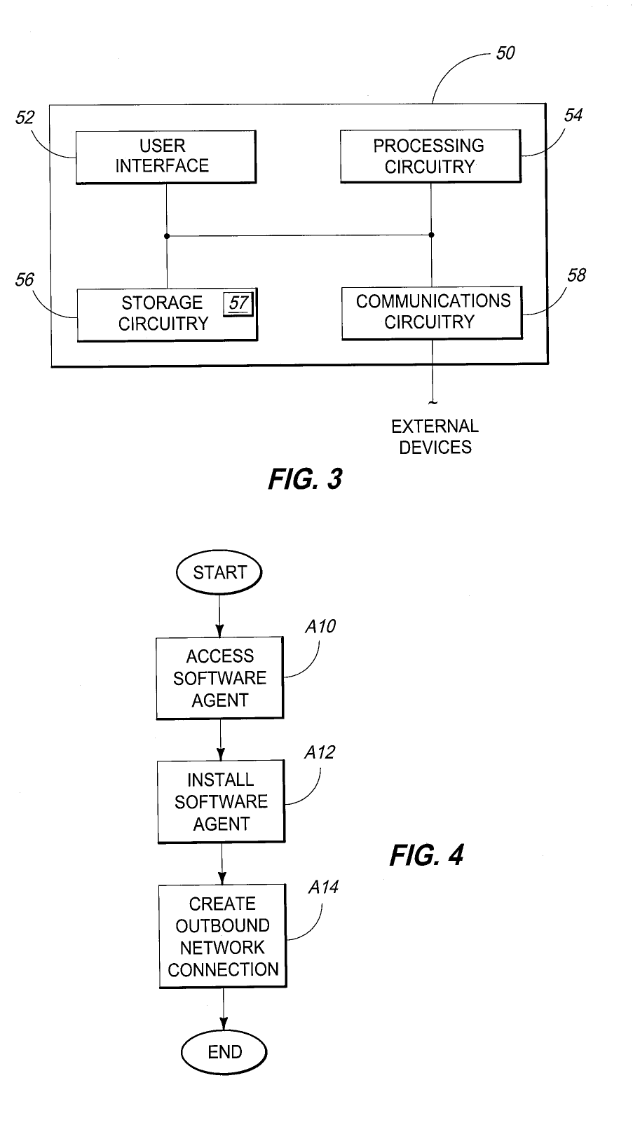

Referring to FIG. 3, a computing system 50 is shown in one illustrative configuration. One or more of the computing devices 12 of the client network 10 and computing devices of the system 20 including provider routing proxy 32 and application server 34 may be implemented using the depicted computing system 50. The illustrated computing system 50 includes a user interface 52, processing circuitry 54, storage circuitry 56, and communications circuitry 58. Other embodiments of computing system 50 may be used including more, less and/or alternative components.

User interface 52 is configured to interact with a user including conveying data to a user (e.g., displaying visual images for observation by the user) as well as receiving inputs from the user. For example, the user interface 52 may depict a web browser which may be accessed by users of the client or the service provider to implement operations discussed herein.

In one embodiment, processing circuitry 54 is arranged to process data, control data access and storage, issue commands, and control other desired operations. For example, processing circuitry 54 of various client and service provider computing devices described herein may implement reverse routing proxy operations, provider routing proxy operations, accessing and/or processing of data, performance of computing services, communications, etc.

Processing circuitry 54 may comprise circuitry configured to implement desired programming provided by appropriate computer-readable storage media in at least one embodiment. For example, the processing circuitry 54 may be implemented as one or more processor(s) and/or other structure configured to execute executable instructions including, for example, software and/or firmware instructions. Other exemplary embodiments of processing circuitry 54 include hardware logic, PGA, FPGA, ASIC, state machines, and/or other structures alone or in combination with one or more processor(s). These examples of processing circuitry 54 are for illustration and other configurations are possible. Processing circuitry 54 herein may refer to processing circuits within one or more computing devices of the client network 10 or computing service system 30. For example, processing circuitry 54 of a client network 10 may refer to processing circuits which reside within one or more computing devices 12 and processing circuitry 54 of a computing service system 30 may refer to processing circuits which reside within one or more computing devices of system 30, such as provider routing proxy 32 and application server 34.

Storage circuitry 56 is configured to store programming of applications such as executable code or instructions (e.g., software and/or firmware), electronic data, databases, corporate data, financial data, client data, or other digital information and may include computer-readable storage media. At least some embodiments or aspects described herein may be implemented using programming stored within one or more computer-readable storage medium of storage circuitry 56 and configured to control appropriate processing circuitry 54.

The computer-readable storage medium may be embodied in one or more articles of manufacture 57 which can contain, store, or maintain programming, data and/or digital information for use by or in connection with an instruction execution system including processing circuitry 54 in the exemplary embodiment. For example, exemplary computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications circuitry 58 is arranged to implement communications of computing system 50 with respect to external devices (not shown). For example, communications circuitry 58 may be arranged to communicate information bi-directionally with respect to computing system 50. Communications circuitry 18 may be implemented as a network interface card (NIC), network interface, serial or parallel connection, USB port, Firewire interface, or any other suitable arrangement for implementing communications with respect to computing system 50. In one more specific embodiment, the communications circuitry 58 of the reverse routing proxy and the provider routing proxy may be used to create the outbound network connection 42 from the client network 10 to the computing service system 30.

Referring to FIG. 4, the depicted flow chart illustrates an example method of implementing communications between the client network 10 and computing service system 30. The described method creates an outbound network connection from the client network 10 to the system 30. Other methods are possible including more, less and/or alternative acts.

At an act A10, a software agent of the system 30 is accessed and which is to be installed on a computing device of the client network. In one embodiment, a client user may send a request for the software agent via a web browser of a client computing device and the service provider may transmit the software agent to the client user.

At an act A12, the client user installs the accessed software agent upon an appropriate computing device within the client network to provide the reverse routing proxy. The software agent contains programming in one embodiment to configure the computing device as the reverse routing proxy.

At an act A14, following installation, the reverse routing proxy creates an outbound network connection with respect to the service provider. In one example, the reverse routing proxy communicates with the provider routing proxy to create the outbound network connection. As described in one example embodiment herein, the reverse routing proxy may thereafter transmit communications to the service provider and the service provider may transmit inbound communications to the client network by tunneling packets via the outbound network connection.

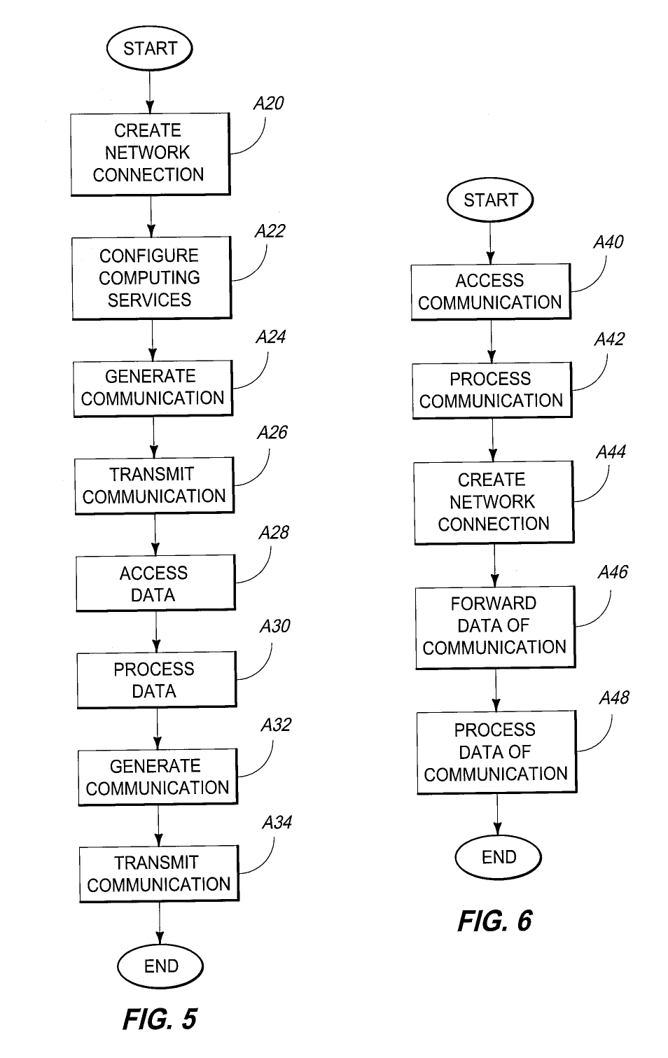

Referring to FIG. 5, the depicted flow chart illustrates an example method of providing computing services by the computing service system 30 to the client network 10. Other methods are possible including more, less and/or alternative acts.

At an act A20, the provider routing proxy receives a communication from a reverse routing proxy requesting the creation of the outbound network connection from the client network to the service provider. The provider routing proxy operates with the reverse routing proxy to create the outbound network connection.

At an act A22, a client user may download a web page from the service provider and configure the provision of the computer services from the service provider to the client. For example, the client user may provide appropriate addresses or ports of computing devices upon the client network which participate in the computing services. For example, addresses of computing devices, which contain data to be accessed by, or actions to be performed by request of the service provider and computing devices of client users who are to receive reports generated by the computing services may be identified for the service provider.

At an act A24, an application of the application server of the service provider may generate a communication during the provision of the computing services to the client. The communication may be addressed to an appropriate computing device of the client network.

At an act A26, the communication is transmitted by the application to the provider routing proxy, and the provider routing proxy is configured to tunnel packets of the communication using the outbound network connection for communication to the reverse routing proxy of the client network.

At an act A28, the application accesses data or applications on a target in the client network. In one example, the communication created in act A24 may include a request for the data from the client.

At an act A30, the application processes the data during the provision of the computing services to the client. For example, the processing of the data may generate a report for use by the client. Other processing apart from generation of reports may also be performed. For example, the processing may generate a communication to order new supplies based upon data from the client indicating that inventory is below a threshold. These processing examples are merely illustrative and other or additional processing services may be performed.

At an act A32, the application of the application server may generate another communication as a result of the processing of the data. This communication may also be addressed to an appropriate computing device of the client network and/or other recipients. For example, data which is processed by the application to perform the computing services may be accessed from a first client computing device and the communication resulting from the processing of the data may be forwarded to a second client computing device and/or other recipient.

At an act A26, the communication is transmitted by the application to the provider routing proxy which outputs the communication to the outbound network connection for communication to the reverse routing proxy of the client network.

Referring to FIG. 6, the depicted flow chart illustrates an example method which may be performed by computing devices of the client network with respect to the computing services provided by the service provider. Other methods are possible including more, less and/or alternative acts.

At an act A40, the reverse routing proxy may receive an inbound communication from the outbound network connection which was transmitted by the provider routing proxy to the client network.

At an act A42, the reverse routing proxy processes data of the inbound communication. For example, the data of the inbound communication may include a connection request which identifies a client computing device within the client network which is to communicate with the application of the service provider during the provision of computing services to the client (e.g., the inbound communication may include a connection request to an address of the appropriate client computing device).

At an act A44, the reverse routing proxy forwards the connection request to the identified client computing device to create an internal network connection within the client network with respect to the client computing device identified in the communication.

At an act A46, the reverse routing proxy forwards data or information of the communication to the client computing device via the internal network connection. Forwarding or communicating data or information of a communication received from the service provider to other client computing devices may include forwarding entireties of the received messages or portions of the received messages (e.g., reports, requests, commands, etc.) to the client computing devices. In one embodiment, the reverse routing proxy is configured to process inbound communications to determine appropriate routing within the client network but the processing of data regarding the computing services provided by the service provider may be implemented using other client computing devices.

At an act A48, the client computing device may thereafter process data of the communication and may take appropriate action. For example, the data of the communication may request that the computing device forward data stored within the computing device to the service provider for the implementation of the computing services by the service provider. In another example, the communication may request that the computing device forward data stored within the computing device to another computing device of the client network, generate a report and forward the report to another computing device of the client network or the application, and/or perform other operations with respect to the computing services.

As discussed herein, at least one embodiment discloses the creation of an outbound network connection from a client network which passes through a firewall of the client network to an external device or external network. An example embodiment of the disclosure permits one or more external device of an external network to create and transmit communications through the firewall to the client network using an established outbound network connection. This example enables different devices of the external network to generate and transmit inbound communications through the firewall to the client network without having to specifically configure the firewall to accept the inbound communications from the different external devices which provides increased flexibility since the computing devices and/or locations of the computing devices of the computing service system of the service provider may dynamically change over time. Furthermore, the external devices may communicate with different addresses or ports in the client network since the reverse routing proxy is located within the client network and may access the computing devices within the client network according to one embodiment.

While the present disclosure has been described with respect to example arrangements of an external computing service system providing computing services to a client network, it is to be understood that the teachings of the disclosure are applicable to other arrangements where external devices may need to communicate with internal devices of a network through a firewall of the network.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An article of manufacture comprising:
a computer-readable storage medium storing programming configured to cause processing circuitry of a client computing device within a client network to perform processing comprising:
creating an outbound network connection to a service provider which is external of the client network and which is to provide computing services to the client network;
accessing an inbound communication from the service provider received via the outbound network connection during the providing of the computing services by the service provider to the client network; and
communicating data of the inbound communication to another client computing device within the client network.

2. The article of claim 1 wherein the programming is configured to cause the processing circuitry to perform processing comprising configuring the client computing device as a reverse routing proxy to perform the creating, the accessing and the communicating.

3. The article of claim 1 wherein the programming is configured to cause the processing circuitry to perform processing comprising creating an internal network connection within the client network to the another computing device as a result of the accessing the inbound communication, and wherein the communicating comprises communicating the data to the another client computing device using the internal network connection.

4. The article of claim 3 wherein the inbound communication identifies the another client computing device to which the internal network connection is to be created.

5. The article of claim 1 wherein the inbound communication comprises a connection request to connect the service provider to the another client computing device.

6. The article of claim 1 wherein the inbound communication comprises a plurality of packets tunneled via the outbound network connection to the client computing device.

7. The article of claim 1 wherein the creating comprises creating the outbound network connection with a provider routing proxy of the service provider.

8. A service provider computing method to provide computing services to a client comprising:
creating a network connection with a first client computing device of a client network to which computing services are to be provided;
after the creating, executing an application to provide the computing services;
during the executing of the application, creating a communication comprising data to be transmitted to a second client computing device of the client network; and
outputting the communication to the network connection for transmission to the second client computing device.

9. The method of claim 8 wherein the data of the communication includes a request for data from the second client computing device, and further comprising:
receiving the requested data from the second client computing device; and
processing the requested data during provision of the computing services.

10. The method of claim 9 further comprising outputting another communication to the network connection for transmission to at least one computing device of the client network, wherein the another communication comprises information resulting from the processing of the requested data.

11. The method of claim 8 wherein the creating comprises creating an inbound network connection with respect to the service provider which was initiated by the first client computing device.

12. The method of claim 8 wherein the outputting comprises tunneling a plurality of packets of the communication using the network connection.

13. The method of claim 8 further comprising communicating programming of a reverse routing proxy to the first client computing device, and wherein the programming of the reverse routing proxy is configured to cause the first client computing device to create the network connection with respect to the service provider.

14. The method of claim 8 further comprising communicating the communication through a firewall of the client network.

15. The method of claim 8 further comprising receiving another communication from the client network via another network connection, and wherein the creating comprises creating as a result of receiving.

16. The method of claim 8 further comprising receiving another communication from the client network which identifies the second client computing device, and further comprising addressing the communication using the identification of the second client computing device.

17. The method of claim 8 wherein the outputting comprises outputting the communication for transmission to the first client computing device prior to transmission to the second client computing device.

18. A computing service system comprising:
communications circuitry configured to create a network connection with a client computing device of a client network;
storage circuitry configured to store an application; and
processing circuitry coupled with the communications circuitry and the storage circuitry, wherein the processing circuitry is configured to:
access a request for computing services;
execute the application as a result of the accessing the request; and
create data as a result of the execution of the application; and
wherein the communications circuitry is configured to output a communication comprising the data to the network connection for communication to the client computing device.

19. The system of claim 18 wherein the processing circuitry is configured to implement provider routing proxy operations to create the network connection comprising an outbound network connection with respect to the client computing device as a result of a request from the client network.

20. The system of claim 18 wherein the communications circuitry is configured to communicate programming of a reverse routing proxy to the client computing device which is configured to cause the client computing device to initiate the creating of the network connection.
